(19) United States
(12) Patent Application Publication
(10) Pub. No.: US 2026/0256137 A1
(43) Pub. Date: Sep. 3, 2026

(54) YEAST-MICROENCAPSULATED LARVICIDE COMPOSITIONS AND METHODS FOR MAKING AND USING THE SAME

(71) Applicant: BOARD OF TRUSTEES OF THE UNIVERSITY OF ARKANSAS, Little Rock, AR (US)

(72) Inventors: Emily MCDERMOTT, Fayetteville, AR (US); Blythe LAWSON, Fayetteville, AR (US)

(73) Assignee: BOARD OF TRUSTEES OF THE UNIVERSITY OF ARKANSAS, Little Rock, AR (US)

(21) Appl. No.: 19/163,807

(22) PCT Filed: Jan. 9, 2024
(86) PCT No.: PCT/US2024/010953

§ 371 Date: Sep. 9, 2025

Related U.S. Application Data
(60) Provisional application No. 63/489,859, filed on Mar. 13, 2023.

(51) Int. Cl. A01N 25/28; A01N 25/14; A01N 43/80; A01P 7/04

(52) U.S. Cl. CPC A01N 25/28; A01N 25/14; A01N 43/80; A01P 7/04

(57) ABSTRACT

The invention is directed to yeast-microencapsulated larvicide compositions for controlling larval pest species in their immature stages before they emerge as adults. The larvicide composition can be used as a cost-effective and efficient method for controlling multiple larval pest species (e.g., Musca domestica, Aedes albopictus, Culicoides sonorensis). The larvicide compositions are made by encapsulating an active isoxazoline larvicide ingredient (e.g., fluralaner) with a yeast cell wall through microencapsulation. In one aspect, an encapsulation solution of active larvicide ingredient, yeast, and water is agitated, and a yeast-microencapsulated fluralaner pellet is separated from the encapsulation solution and is freeze-dried to obtain a dry, shelf-stable powdered larvicide composition that can be reconstituted with water and applied to aquatic or terrestrial larval development substrates in the same manner as other wettable powders or granulated insecticides.

### CROSS-REFERENCE TO RELATED APPLICATIONS

This application claims the benefit of U.S. Provisional Patent Application No. 63/489,859, filed Mar. 13, 2023, and said application is incorporated by reference in its entirety into this document as if fully set out at this point.

### GOVERNMENT LICENSE RIGHTS

This invention was made with U.S. Government support under the Deployed Warfighter Protection Research Program (DWFP) (Grant No. W911QY2210003) awarded by the United States Department of Defense and administered by the Armed Forces Pest Management Board (AFPMB). The Government has certain rights in this invention.

### BACKGROUND OF THE INVENTION

### 1. Field of the Invention

This invention generally relates to yeast-microencapsulated isoxazoline larvicide compositions and methods of making and using the same, and more particularly, to yeast-microencapsulated fluralaner compositions, methods of making the compositions, and methods of using the compositions for controlling larval pest species, namely flies, mosquitoes, biting midges, in their immature stages, before they emerge as adults.

### 2. Description of the Related Art

Fly control for any species is most effective when targeted in the immature stages when insects can be eliminated before emerging as adults capable of transmitting pathogens or becoming nuisance pests. Currently, a limited number of insecticide classes are available for treating larval development sites for any species. Options for mosquito larval control are the most varied, and commercially available products containing Bt toxins, insect growth regulators (IGRs), and organophosphates can be purchased for use in the United States. However, fewer products are labeled for the larval control of other vector and nuisance species, including biting midges and house flies. Products applied against these insects primarily target the adult stage, when population management is more difficult.

One potential solution to the current lack of effective larvicides is fluralaner. Fluralaner is a relatively new insecticide in the novel isoxazoline class, first approved for sale in the United States in 2014. Fluralaner's mode of action (GABA-antagonist) differs from other pesticides currently on the market. As a result, it has tremendous potential to be included in a pesticide rotation to reduce the risk of developing resistance in target arthropod populations. Currently, in the United States, fluralaner is labeled against fleas and ticks on companion animals (Bravecto®), and, in Europe, fluralaner is labeled against mites on poultry (Exzolt®). However, research has shown that fluralaner may have a wider target range beyond ectoparasites and could be developed as an effective environmental insecticide for vector control.

As the larvae of many pest species, including mosquitoes, biting midges, and house flies, are detritivorous and consume a variety of microorganisms in their habitats, yeasts are also readily consumed and digested by these target species. Yeast microencapsulation (YME) is a technique that takes advantage of the ability of low molecular weight compounds to pass through the cell wall of common baker's yeast, Saccharomyces cerevisiae. YME has been used to improve the solubility of hydrophobic compounds in aqueous solutions and improve the absorption of drug compounds in the body. YME has also garnered interest in the vector control community for its potential to be used as a vehicle for insecticide applications, particularly of plant essential oils, which have demonstrated toxicity but cannot be readily applied to water. As an insecticide vehicle, yeasts can prevent the active ingredient from being freely dispersed into the environment, protect non-target organisms, and protect the active ingredient from environmental degradation caused by ultraviolet light.

### SUMMARY OF THE INVENTION

Accordingly, it is an object of this invention to provide yeast-microencapsulated fluralaner compositions for controlling larval pest species in their immature stages before they emerge as adults. The larvicide composition can be used as a cost-effective and efficient method for controlling multiple larval pest species, including without limitation Musca domestica, Aedes albopictus, Culicoides sonorensis. The YME larvicide compositions are easily stored, applied to larval habitats, and consumed by larval insects that naturally feed on detritus (decaying matter), bypassing the cuticle.

Another object of the invention is to provide a method for manufacturing the larvicide composition by encapsulating the active isoxazoline larvicide ingredient (e.g., fluralaner) with a yeast cell wall through yeast microencapsulation. The YME larvicide is freeze-dried to obtain a dry, shelf-stable powder that can be reconstituted with water and applied to aquatic or terrestrial larval development substrates in the same manner as other wettable powders or granulated insecticides.

In general, in a first aspect, the invention relates to a yeast-microencapsulated larvicide composition having an active larvicide ingredient with at least one isoxazoline compound and a yeast of species Saccharomyces cerevisiae, and the at least one isoxazoline compound is microencapsulated in the yeast.

In an embodiment, the at least one isoxazoline compound is fluralaner.

In an embodiment, the yeast-microencapsulated larvicide composition has a yeast concentration of between about 0.000077 mg/mL and about 23.13 mg/mL (and any range or value therebetween), and a fluralaner concentration of about 83.5 mg fluralaner per 1 g of yeast.

In general, in a second aspect, the invention relates to a method for fabricating a powdered larvicide composition. The method includes preparing an encapsulation solution having a predetermined concentration of an active larvicide ingredient with fluralaner, yeast of species Saccharomyces cerevisiae, and water. The encapsulation solution is agitated at a predetermined incubation temperature to obtain an incubated encapsulation solution, and then a yeast-encapsulated fluralaner pellet is separated from the incubated encapsulation solution. The yeast-encapsulated fluralaner pellet is freeze-dried at a predetermined freeze-drying temperature to form the powdered larvicide composition.

In an embodiment, the step of preparing the encapsulation solution can also include dissolving the fluralaner in dimethyl sulfoxide to obtain a fluralaner/dimethyl sulfoxide solution and then adding the yeast and the water to the fluralaner/dimethyl sulfoxide solution.

In an embodiment, the step of separating the yeast-microencapsulated fluralaner pellet from the incubated encapsulation solution step can also include the steps of centrifuging the encapsulation solution to form a supernatant and a yeast-microencapsulated fluralaner pellet, removing the supernatant from the yeast-microencapsulated fluralaner pellet, and washing the yeast-microencapsulated fluralaner pellet.

In an embodiment, the step of freeze-drying the yeast-microencapsulated fluralaner pellet can also include the step of lyophilizing the yeast-microencapsulated fluralaner pellet at a predetermined freeze-drying temperature under a predetermined vacuum pressure to form the powdered larvicide composition.

In an embodiment, the encapsulation solution has a concentration ratio of about 3 to about 7 parts fluralaner (and any range or value therebetween), about 0.5 to about 2 parts yeast (and any range or value therebetween), and about 20 to about 40 parts water (and any range or value therebetween).

In an embodiment, the encapsulation solution has a concentration ratio of about 6.7 parts fluralaner to about 1 part yeast to about 33.3 parts water.

In an embodiment, the agitating step can include agitating the encapsulation solution at a predetermined incubation temperature of about 40° C. for about 24 hours.

In general, in a third aspect, the invention relates to a method of preventing or controlling larval pest species by reconstituting a powdered larvicide composition to a yeast-microencapsulated fluralaner solution and administering the yeast-microencapsulated fluralaner solution to a target environment. The powdered larvicide composition includes a larvicide ingredient having fluralaner and a yeast of species Saccharomyces cerevisiae, where the fluralaner is microencapsulated in the yeast.

In an embodiment, the larval pest species is flies, mosquitoes, or biting midges, and the yeast-microencapsulated fluralaner solution is administered to an aquatic or terrestrial environment where the larval pest species are developing.

In an embodiment, the powdered larvicide composition is diluted with about 1 mg/mL to about 50 mg/mL (and any range or value therebetween) of water to reconstitute the powdered larvicide composition.

In an embodiment, the fluralaner in the yeast-microencapsulated fluralaner solution has a concentration of between about 0.1544753 mg/mL and about 138.2862 mg/mL (and any range or value therebetween), and the larval pest species is Musca domestica.

In an embodiment, the fluralaner in the yeast-microencapsulated fluralaner solution has a concentration of between about 2.58 mg/mL and about 23.13 mg/mL (and any range or value therebetween), and the larval pest species is Musca domestica.

In an embodiment, the powdered larvicide composition is reconstituted by diluting with about 0.00001 mg/mL to 0.1 mg/mL (and any range or value therebetween) of water.

In an embodiment, the powdered larvicide composition has a concentration of between about 8.357474×10⁻⁶ mg/mL and about 0.001781345 mg/mL (and any range or value therebetween), and the larval pest species is Aedes albopictus.

In an embodiment, the powdered larvicide composition has a concentration of between about 0.000077 mg/mL and about 0.11637 mg/mL (and any range or value therebetween), and the larval pest species is Aedes albopictus.

In an embodiment, the powdered larvicide composition has a concentration of between about 0.000077 mg/mL and about 0.00043 mg/mL (and any range or value therebetween), and the larval pest species is Aedes albopictus.

In an embodiment, the fluralaner in the yeast-microencapsulated fluralaner solution has a concentration of between about 8.965623×10⁻⁷ mg/mL and about 7.78805 mg/mL (and any range or value therebetween), and the larval pest species is Culicoides sonorensis.

In an embodiment, the fluralaner in the yeast-microencapsulated fluralaner solution has a concentration of between about 0.00067 mg/mL and about 0.11637 mg/mL (and any range or value therebetween), and the larval pest species is Culicoides sonorensis.

### BRIEF DESCRIPTION OF THE DRAWINGS

The above and other objects and advantages of this invention may be more clearly seen when viewed in conjunction with the accompanying drawings wherein:

FIG. 1 is an HPLC chromatogram image of fluralaner-encapsulated yeast cells in accordance with an illustrative embodiment of the invention disclosed herein.

FIG. 2 is an HPLC chromatogram image of aliquots of supernatant from the washing of fluralaner-encapsulated yeast cells in accordance with an illustrative embodiment of the invention disclosed herein.

FIG. 3 depicts survivorship curves for Ae. albopictus larvae after treatment with a commercial off-the-shelf product in comparison with yeast-microencapsulated fluralaner in accordance with an illustrative embodiment of the invention disclosed herein.

FIG. 4 depicts an exemplary bucket trap used for semi-field experiments with house flies.

FIGS. 5A and 5B depict, respectively, average pupation over time and average emergence over time for control and treatment groups of Ae. albopictus.

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

The invention generally relates to yeast-microencapsulated isoxazoline larvicide compositions and methods of making and using the same, and more particularly, the invention relates to yeast-microencapsulated fluralaner compositions, methods of making the compositions, and methods of using the compositions for controlling larval pest species, namely flies (e.g., Order: Diptera, Suborder: Brachycera, Family: Muscidae, Genus: Musca, Species: M. domestica), mosquitoes (e.g., Order: Diptera, Suborder: Nematocera, Family: Culicidae, Genus: Aedes, Species: Ae. albopictus), biting midges (e.g., Order: Diptera, Suborder: Nematocera, Family: Ceratopogonidae, Genus: Culicoides, Species: C. sonorensis), in their immature stages, before they emerge as adults. The inventive method first prepares an encapsulation solution from an active larvicide ingredient having at least one isoxazoline compound (e.g., fluralaner) in a predetermined concentration, a yeast, and water, such as with concentration ratios of about 3 to about 7 parts isoxazoline compound (and any range or value therebetween), about 0.5 to about 2 parts yeast (and any range or value therebetween), and about 20 to about 40 parts water (and any range or value therebetween), and more particularly about 6.7 parts isoxazoline compound to about 1 part yeast to about 33.3 parts water. In one embodiment, in order to form the encapsulation solution, fluralaner is dissolved in dimethyl sulfoxide (DMSO) to obtain a fluralaner/dimethyl sulfoxide solution, and then a yeast of species Saccharomyces cerevisiae (commonly known as “baker's yeast”) and water are added thereto. The yeast may be delivered in a pharmaceutically acceptable carrier, and the isoxazoline compound in the encapsulation solution is microencapsulated in the yeast. The encapsulation solution is then agitated at a predetermined incubation temperature (e.g., between about 40° C. and about 45° C., and any range or value therebetween) for a predetermined amount of incubation time (e.g., about 24 hours to about 36 hours, and any range or value therebetween), resulting in an incubated encapsulation solution. Following incubation, the incubated encapsulation solution is centrifuged to form a supernatant and a yeast-microencapsulated fluralaner pellet, and the supernatant is removed from the yeast-microencapsulated fluralaner pellet, which is washed with water. The yeast-microencapsulated pellet is then lyophilized or freeze-dried under a predetermined vacuum pressure (e.g., about 0 standard atmosphere (atm), or 50 m Torr) at a predetermined freeze-drying temperature (e.g., about −30° C. to about −50° C., and any range or value therebetween, more particularly about −40° C.) for a predetermined amount of drying time (e.g., about 22 hours to about 24 hours, and any range or value therebetween) to form a dry, shelf-stable powdered larvicide composition. The powdered larvicide composition has a yeast concentration between about 0.000077 mg/mL and about 23.13 mg/mL (and any range or value therebetween) and a fluralaner concentration of about 83.5 mg fluralaner per 1 g of yeast.

For use as a larvicide to prevent or control larval pest species, the powdered larvicide composition can be reconstituted with water, and the resulting yeast-microencapsulated fluralaner solution can be applied to a target environment (e.g., aquatic or terrestrial larval development substrates) like other wettable powders or granulated insecticides. The yeast-microencapsulated fluralaner solution is suitable to target larval pest species including, but not limited to, flies (e.g., Musca domestica), mosquitoes (e.g., Aedes albopictus), and biting midges (e.g., Culicoides sonorensis). For controlling M. domestica, the powdered larvicide composition can be diluted with about 1 mg/mL to about 50 mg/ml of water (and any range or value therebetween) for a lethal concentration (LC) of between about 0.1544753 mg/mL (LC₅) and about 138.2862 mg/mL (LC₉₉) (and any range or value therebetween), and more particularly between about 2.58 mg/mL (LC₅₀) and about 23.13 mg/mL (LC₉₀). Similarly, for controlling C. sonorensis, and Ae. albopictus, the powdered larvicide composition can be diluted with about 0.00001 mg/mL to about 0.1 mg/ml of water (and any range or value therebetween) for an LC of between about 8.357474×10⁻⁶ mg/mL (LC₅) and about 0.001781345 mg/mL (LC₉₉) (and any range or value therebetween), and more particularly between about 0.000077 mg/mL (LC₅₀) and about 0.00043 mg/mL (LC₉₀) for Ae. albopictus, and between about 8.965623×10⁻⁷ mg/mL (LC₅) and about 7.78805 mg/mL (LC₉₉) (and any range or value therebetween), and more particularly between about 0.00067 mg/mL (LC₅₀) and about 0.11637 mg/mL (LC₉₀) for C. sonorensis. The yeast-microencapsulated fluralaner solution can then be administered to an aquatic or terrestrial environment where the larval pest species are developing, namely puddles, trash, manure, ponds, and buckets.

Reapplication of the YME fluralaner solution to the aquatic or terrestrial environment may be desirable for ongoing control of certain larval pest species. Suitable reapplication intervals include, without limitation, approximately every one week, two weeks, three weeks, four weeks, and five weeks. For controlling Ae. albopictus, the reapplication interval can be approximately every five weeks. For controlling M. domestica, the YME fluralaner solution can be reapplied weekly (i.e., every 7 days).

Because the YME fluralaner solution (and its powdered larvicide composition form) has an active ingredient in a different class of insecticide with a different mode of action than available mosquito and house fly larvicides and midge insecticides, the inventive larvicide can be used in a pesticide rotation to reduce the risk of resistance development in pest populations.

### EXAMPLES

The yeast-microencapsulated fluralaner compositions and methods of using the same are further illustrated by the following examples, which are provided for the purpose of demonstration rather than limitation.

### Example 1

The constituents for microencapsulation were combined in a 1 L glass, baffled flask in the ratio of 6.7:1:33.3 (active ingredient (AI):yeast:ddH₂O). Here, 402 mg of technical grade fluralaner (BOCSCI Inc., Shirley, NY) was dissolved in 13.4 mL of dimethyl sulfoxide (DMSO) (Thermo Scientific, Rockford, IL) to the concentration of 30 mg fluralaner/1 mL DMSO. Once dissolved, 2000 mg of baker's yeast, Saccharomyces cerevisiae, (Sigma Life Sciences) and 66.6 mL of ddH₂O were added to the flask. This mixture was continuously agitated for 24 hours at 40° C. in an incubated shaker. The flask was capped and tightly sealed with parafilm to avoid evaporation. Following the incubation period, this solution was split equally between two 50 mL falcon tubes for immediate centrifugation. The solution was centrifuged for 10 minutes at 23° C. and 2000×g. The supernatant was decanted off, and then 45 mL of ddH₂O was added into each tube. The pellets were thoroughly resuspended into solution by vortexing. This wash step was repeated five times, with 100 mL of each wash supernatant set aside for high-pressure liquid chromatography (HPLC) analysis. After decanting off the supernatant from the final wash, all remaining liquid was removed from the pellets by micropipette. Pellets were stored at −80° C. until completely frozen before being lyophilized for 22-24 hours. The dry powder resultant from lyophilization was stored at room temperature until used. The powdered product was then weighed and reconstituted in ddH₂O to reach desired dilutions.

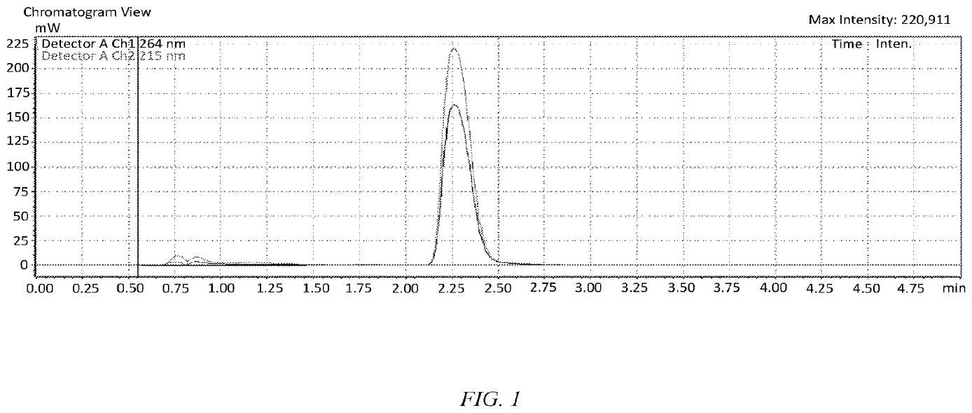

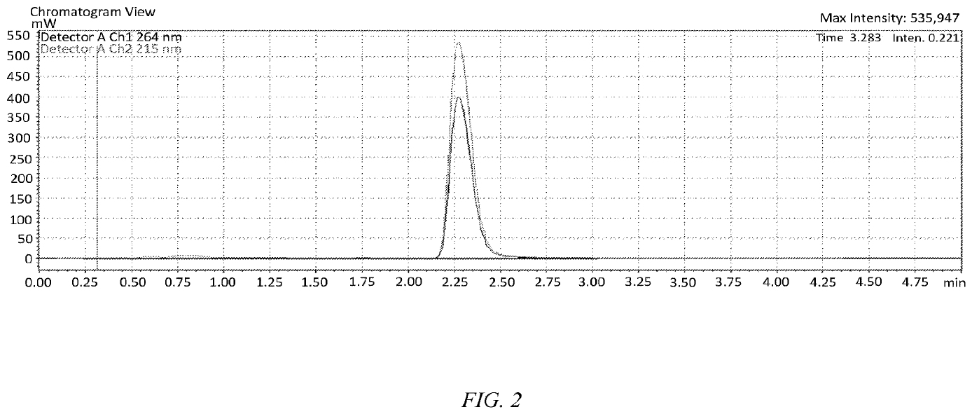

To validate the encapsulation of fluralaner within the yeast cell wall, ethanol extractions were conducted on the final products. Extraction by bead milling using 0.5 mm zirconium oxide beads (NextAdvance, Eppendorf®, Hamburg, Germany) were used. The extracts were vacuum-filtered through a Millipore Express PLUS membrane (0.22 μm) (EMD Millipore®, Burlington, MA), and these filtrates were stored at −20° C. The samples (3 μmL injection volume) were analyzed for fluralaner with HPLC. The HPLC system (Shimadzu Nexera, Shimadzu, Kyoto, Japan) included a binary solvent delivery system at a flow rate of 0.2 mL/min, an autosampler, and an ultraviolet, dual detector set at a wavelength of 264 nm. Pure fluralaner (AccuStandard®, New Haven, CT) for analytical reference was used to prepare a stock solution. A calibration curve for fluralaner included six (6) standard solutions that ranged from 3.125 g/mL to 100 μg/mL and included a blank (0 μg/mL) sample. The calibration curve was accepted if the linear coefficient of determination (R²) was ≥0.99. Chromatograms were integrated with HPLC software (OpenLAB software, Agilent Technologies). A C-18 column (1.8 μm, 50×2.1 mm) (Shimadzu Nexcol, Shimadzu, Kyoto, Japan) was used to separate peaks at a constant temperature (40° C.) under isocratic conditions with a mobile phase of acetonitrile and water (70:30 v:v) (see FIG. 1). In addition to quantifying the fluralaner present within the microencapsulated product, HPLC analysis was conducted on aliquots of supernatant saved from each wash step during product formulation (see FIG. 2). The fluralaner present after each wash was quantified such that residual levels could be tracked during the preparation process and aided in further validation of encapsulation yield.

YME methods were evaluated for efficiency. Variable encapsulation conditions were assessed in eight (8) different combinations, with two (2) replicates per combination (Table 1 below). For plasmolysis, 1000 mg of yeast was incubated with 2 mL of a 2% NaCl solution at 40° C. for 48 hours in an incubated shaker. Yeast was then incubated at 85° C. for 15 minutes before being washed and lyophilized. Osmolysed, lyophilized yeast was then used for microencapsulation following the steps as previously outlined. The results indicate that fluralaner (molecular weight 556.3 g/mol), under these conditions, has an average encapsulation efficiency of 41.5%, as its molecular weight is approaching YME limits (620 g/mol). No significant effect of condition type on encapsulation efficiency was observed.

TABLE 1
Encapsulation Efficiency

| | Time | Temp. | | | | | Conc. | Encapsulation |
|---|---|---|---|---|---|---|---|---|
| No. | (hr) | (° C.) | Plasmolysis | Dilution | Area | Rt | (mg) | Efficiency % |
| 1 | 24 | 40 | — | 1/100 | 6813603 | 2.25 | 20.32881 | 0.405 |
| 2 | 24 | 40 | — | 1/100 | 7623062 | 2.26 | 22.73018 | 0.452 |
| 3 | 24 | 40 | 2% NaCl | 1/100 | 7306644 | 2.26 | 21.79148 | 0.434 |
| 4 | 24 | 40 | 2% NaCl | 1/100 | 6868667 | 2.26 | 20.49217 | 0.408 |
| 5 | 36 | 40 | — | 1/100 | 6764329 | 2.26 | 20.18263 | 0.402 |
| 6 | 36 | 40 | — | 1/100 | 6723051 | 2.25 | 20.06018 | 0.399 |
| 7 | 36 | 40 | 2% NaCl | 1/100 | 9314302 | 2.25 | 27.74746 | 0.552 |
| 8 | 36 | 40 | 2% NaCl | 1/100 | 6545156 | 2.25 | 19.53243 | 0.389 |
| 9 | 24 | 45 | — | 1/100 | 6314187 | 2.24 | 18.84723 | 0.375 |
| 10 | 24 | 45 | — | 1/100 | 7041737 | 2.23 | 21.0056 | 0.418 |
| 11 | 24 | 45 | 2% NaCl | 1/100 | 6476997 | 2.25 | 19.33023 | 0.385 |
| 12 | 24 | 45 | 2% NaCl | 1/100 | 8201316 | 2.26 | 24.44564 | 0.486 |
| 13 | 36 | 45 | — | 1/100 | 7061706 | 2.27 | 21.06484 | 0.419 |
| 14 | 36 | 45 | — | 1/100 | 6521188 | 2.27 | 19.46132 | 0.387 |
| 15 | 36 | 45 | 2% NaCl | 1/100 | 6103779 | 2.26 | 18.22303 | 0.363 |
| 16 | 36 | 45 | 2% NaCl | 1/100 | 6226324 | 2.26 | 18.58657 | 0.37 |

Product efficacy was evaluated using dose-response assays against the larvae of three (3) medically important fly species: house flies (Musca domestica), Asian tiger mosquitoes (Aedes albopictus), and biting midges (Culicoides sonorensis). Preliminary susceptibility trials were performed on late-stage larvae to determine the appropriate range of concentrations for bioassays. Tested dilution ranges for M. domestica was 1 mg/mL to 50 mg/mL and for C. sonorensis, and Ae. albopictus was 0.00001 mg/mL to 0.1 mg/mL. Each trial had a negative control group (ddH₂O) and a positive control group (untreated yeast). The positive control, or untreated yeast, was diluted in ddH₂O to match the highest concentration of encapsulated yeast for each trial. The three (3) larval species evaluated in this study have distinct habitats, and the application methods and media types used during bioassays reflect that difference. M. domestica is terrestrial (e.g., decaying waste or manure), and as such, the formulated product was added to solid media. In contrast, both C. sonorensis and Ae. albopictus larvae are aquatic (e.g., ponds and silty water), so product efficacy was evaluated by applying liquid media (water). Extra deep petri dishes (26×10⁰ mm) were prepared with either 50 g of solid media, or 50 mL of ddH₂O. One milliliter (1 mL) of encapsulated yeast dilution treatments were added to each replicate and thoroughly homogenized prior to adding larvae. For all replicates within all trials, 5-20 late-stage larvae (L3 for M. domestica, and L4 for C. sonorensis and Ae. albopictus) were immediately added to each petri dish of media. Mortality was assessed at 24 hours.

The concentration of YME fluralaner predicted to kill 50% of exposed larvae (LC₅₀) was calculated using probit analyses, using a correction for control mortality if it exceeded 5%. The predicted LC₅₀ values for each species are as follows:
M. domestica: 2.58 mg/mL (2580 ppm)
Ae. albopictus: 0.000077 mg/mL (0.077 ppm)
C. sonorensis: 0.00067 mg/mL (0.67 ppm)

The concentration of YME fluralaner predicted to kill 90% of exposed larvae (LC₉₀) was also calculated, and the predicted LC₉₀ values for each species are as follows:
M. domestica: 23.13 mg/mL (23130 ppm)
Ae. albopictus: 0.00043 mg/mL (0.43 ppm)
C. sonorensis: 0.11637 mg/mL (116.37 ppm)

### Example 2

Tests were performed to compare the performance of the inventive yeast-microencapsulated fluralaner compositions with that of commercial off-the-shelf (COTS) products that are currently available for controlling mosquito larvae. Several mosquito larvicides are available using a variety of active ingredients. These products are applied to aquatic larval development sites as sprays, granules, and slow-release tablets. In this Example, the efficacy of the inventive YME fluralaner composition was compared to that of Bacillus thuringiensis israelensis (available as COTS product VectoBac®).

For these tests, 1 L deionized water was added to 1 ft² pans. The VectoBac® was applied at the label rate to the pans, while the yeast-microencapsulated fluralaner composition was applied at the previously determined LC₉₀ dose for Ae. albopictus. Control pans did not receive any additional material. Three replicate pans per treatment were used, and at t0, 30 L4 Ae. albopictus larvae were added to each pan. At twenty-four (24) hours after application, the average percent mortality of the larvae was assessed by counting the number of pupae and live larvae in each pan.

As shown in Table 2, the yeast-microencapsulated fluralaner provided equivalent control to VectoBac®, with both treatments averaging 100% mortality at 24 h, compared to 2.13% in the control.

TABLE 2
Average Percent Mortality for Ae. albopictus Larvae

| Treatment | Mean 24 hr Mortality (%) | SD |
|---|---|---|
| Control | 2.13 | 3.24 |
| VectoBac ® | 100 | 0 |
| YME Fluralaner | 100 | 0 |

### Example 3

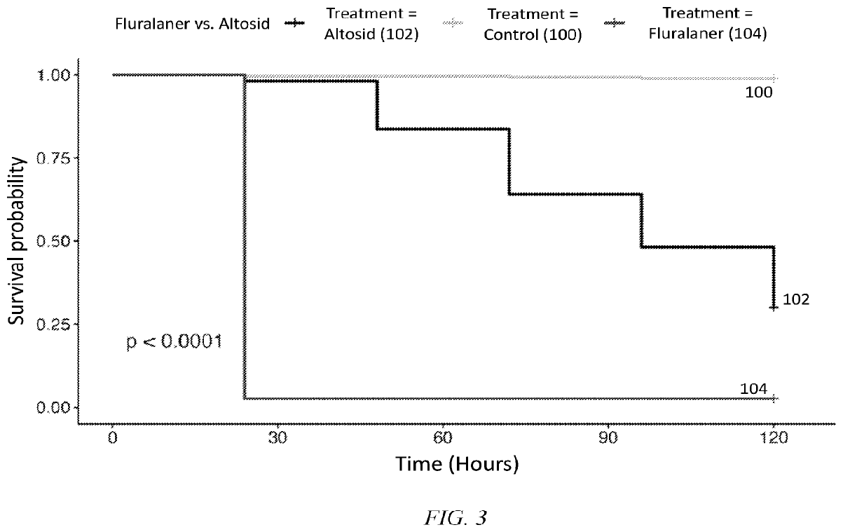

The performance of the inventive yeast-microencapsulated fluralaner compositions was also compared with that of methoprene (available as COTS product Altosid®). For these tests, 1 L deionized water was added to 1 ft² pans. Three replicate pans per treatment were used, and at 10, 30 L4 Ae. albopictus larvae were added to each pan, with separate samples of Ae. albopictus larvae treated with 0.0004 mg/mL yeast-microencapsulated fluralaner (LC₉₀) or the label application rate of Altosid®. FIG. 3 depicts survivorship curves for the Ae. albopictus larvae from 24 to 120 hours post-application. Curve 100 for the control sample demonstrated very little change, while curve 102 for the Altosid® exhibited a progressive decrease in survival probability over 120 hours. In contrast, curve 104 indicates that the yeast-microencapsulated fluralaner resulted in a dramatic reduction in survival probability by 24 hours post-application and surpassed the Altosid® treatment in performance, even at 120 hours post-application. All pairwise comparisons of survivorship curves were significantly different (P<0.0001). Crosses at the end of the curves indicate surviving larvae were present at 120 hours.

### Example 4

Additional tests were performed to investigate a) the duration for which the inventive yeast-microencapsulated fluralaner compositions provide acceptable control of larval house flies (M. domestica), mosquitoes (Ae. albopictus), and biting midges (C. sonorensis); b) appropriate reapplication intervals for the inventive yeast-microencapsulated fluralaner compositions; and c) appropriate application techniques for terrestrial house fly habitats. More particularly, semi-field trials were conducted to determine reapplication intervals and the performance of the inventive yeast-microencapsulated fluralaner compositions under natural environmental conditions. With the exception of C. sonorensis, all trials were conducted outdoors at the Milo J. Shult Agricultural Research & Extension Center on the University of Arkansas campus. The available Van Ryn colony of C. sonorensis were unable to survive outdoors in adequate numbers for these trials. Daily temperature and precipitation were recorded from the Southern Regional Climate Center-Fayetteville Experiment Station weather station (ID #032444).

### Experimental Set-Up.

For the trials using Ae. albopictus and C. sonorensis, 200 mL of dechlorinated water was added to a mosquito-breeder emergence container and treated with the predetermined LC₅₀ YME fluralaner concentration. For the Ae. Albopictus containers, one Cichlid fish food pellet (0.18 g) and 1 mL of oak leaf infusion (aged 1 month) were also added to each container on day zero to simulate a natural habitat, in which additional resources are available. An additional fish food pellet was added to each of these container every two weeks. For the C. sonorensis containers, 1 mL of nutrient broth, 1 mL of bacterial inoculation (derived from lab colony pans), and rearing media (alfalfa, yeast and albumin mix) were added, in addition to polyester batting for pupation on day zero. An additional 1 mL of nutrient broth was added to each of these container every week. On day zero, 10 or 20 L4 Ae. albopictus or C. sonorensis larvae were added to each container, depending on availability. Seven days after initial treatment, the number of dead larvae, live larvae, pupae, and emerged adults were recorded. All individuals were removed prior to adding another 10 or 20 L4 Ae. albopictus or C. sonorensis larvae. This process was repeated weekly until greater than 50% emergence was reached. To account for evaporation, additional water was added as needed. The Ae. albopictus Trial 1 was conducted outside, but due to the longevity of the trial coinciding with temperature drops, Trial 2 was conducted indoors.

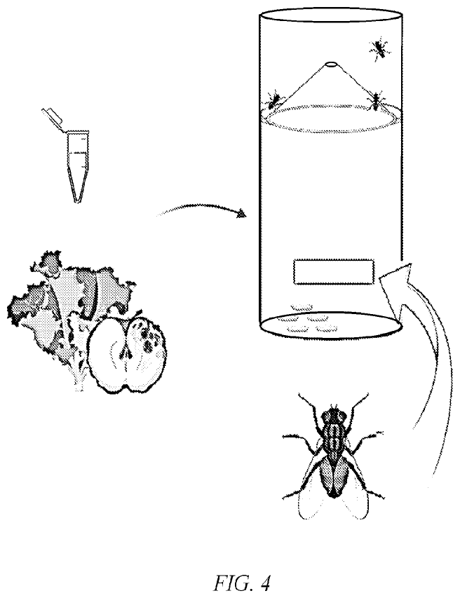

For the trials with house flies, bucket traps were constructed from 5-gallon plastic buckets (see FIG. 4). Approximately 21 ounces of organic, standardized food waste (one half apple (diced), one banana (squished), 4 mL peeled, shredded carrots, half a head of iceberg lettuce (torn), two tomatoes (squished), and 10 mL of powdered milk) was added to the bottom of each bucket, and natural colonization was permitted throughout decomposition. Each bucket, regardless of treatment group, received an additional 21 ounces of this standardized food waste every seven days. One treatment group was treated with the predetermined LC₅₀ YME fluralaner concentration for M. domestica on day zero, with no reapplication of product thereafter. The other treatment group received reapplication of the LC₅₀ concentration every seven days, when more food waste was also added to the bucket. The control group received no product application. Every seven days, up to four weeks, the number of emerged flies collected in the upper chamber of the bucket trap were counted, removed, identified to family and recorded. There were five replicates per treatment, and two trials. Bucket traps were randomly assigned positions within a 20 meter×12 meter grid at 4 meters apart.

Results for Mosquitoes (Ae. albopictus).

Because of differences in the experimental conditions, Trials 1 and 2 were considered separately.

Trial 1 was conducted outdoors for seven weeks, starting in mid-September. The treatment containers never reached a larval survival above 50%, with the highest being 12% on week 7. The average weekly survival of larvae in the Ae. albopictus treatment containers was 4%. Due to temperature fluctuations, mortality in the control container was 57% at week 6 and 47% at the following time point.

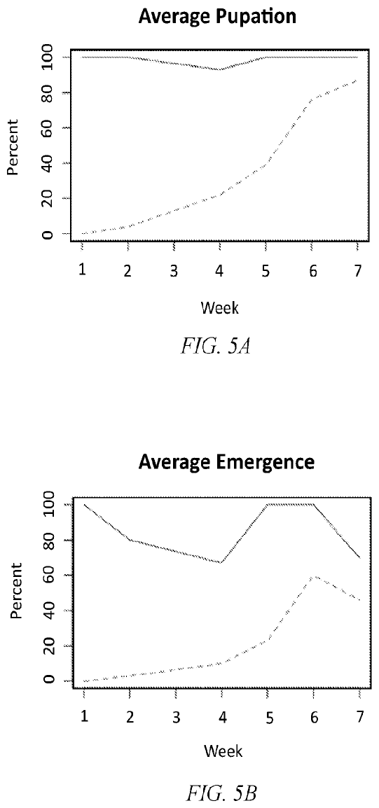

Due to the longevity of the trial, Trial 2 was conducted indoors where temperature variables could be controlled. Pupation greater than 50% (76%) was reached at week 6 for the Ae. albopictus containers that were treated with LC₅₀ YME fluralaner concentration on day zero. Emergence greater than 50% (60%) was reached at week 6 for the containers treated with the LC₅₀ concentration on day zero. FIG. 5A depicts the average pupation over time for Ae. albopictus during Trial 2, while FIG. 5B depicts the average emergence over time. The solid lines in FIGS. 5A and 5B represent the control containers, while the dotted lines represent the treatment containers. The average proportional pupation and emergence for Ae. albopictus are also shown in Table 3 below.

TABLE 3
Aedes albopictus Average Proportional Pupation and Emergence.

| | Control | Treatment | Control | Treatment |
|---|---|---|---|---|
| | Average | Average | Average | Average |
| Week | Pupation | Pupation | Emergence | Emergence |
| 1 | 1 | 0 | 1 | 0 |
| 2 | 1 | 0.04 | 0.8 | 0.03 |
| 3 | 0.93 | 0.22 | 0.67 | 0.1 |
| 4 | 1 | 0.39 | 1 | 0.23 |
| 5 | 1 | 0.76 | 1 | 0.6 |
| 6 | 1 | 0.87 | 0.7 | 0.46 |
| 7 | 1 | 0 | 1 | 0 |

These results indicate that a suitable reapplication period for the LC₅₀ YME fluralaner concentration to control larval mosquitoes is about every 5 weeks.

Results for Biting Midges (C. sonorensis).

Multiple attempts to conduct C. sonorensis trials outdoors were made, but adequate survival was not achieved. The available Van Ryn colony is laboratory established, as indicated by excessive control mortality. One trial was conducted indoors, with the results depicted in Table 4. At week 8, all containers treated with LC₅₀ YME fluralaner concentration on day zero still yielded 0% pupation, while all control containers exhibited 100% pupation.

TABLE 4
Culicoides sonorensis Average Proportional Pupation.

| | Control Average | Treatment Average |
|---|---|---|
| Week | Pupation | Pupation |
| 1 | 1 | 0 |
| 2 | 1 | 0 |
| 3 | 0.97 | 0 |
| 4 | 1 | 0 |
| 5 | 1 | 0 |
| 6 | 1 | 0 |
| 7 | 1 | 0 |
| 8 | 1 | 0 |

### Results for House Flies.

One trial was conducted outdoors. Adult flies emerged from the bucket traps were identified to family as Muscidae, Calliphoridae, Sarcophagidae, and Drosophilidae. Analysis of these data by family are ongoing. It will be appreciated that the inventive YME fluralaner compositions may be suitable for targeting larval pest species in one or more of these families. As shown in Table 5, the only significant difference was observed in the average number of total flies emerged in week 2 in the reapplication bucket (which received reapplication of the LC₅₀ concentration every seven days) when compared to the control bucket.

TABLE 5
Average Total Emergence for Each
Treatment Group of House Flies.

| | Average Total Emergence | | | |
|---|---|---|---|---|
| Treatment Group | Week 1 | Week 2 | Week 3 | Week 4 |
| Control | 13.2 | 31* | 14.2 | 23.2 |
| Single Application of LC₅₀ | 5.2 | 9.2 | 12.4 | 18.4 |
| Reapplication of LC₅₀ | 4.6 | 2.4* | 12 | 10.8 |

*Asterisks indicate significantly different means (P < 0.05).

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only, and various modifications may be made by those skilled in the art. The above specification, examples, and data provide a complete description of the structure and use of exemplary embodiments. Although various embodiments have been described above with a certain degree of particularity or with reference to one or more individual embodiments, those skilled in the art could make numerous alterations to the disclosed embodiments without departing from the spirit or scope of this specification.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description and with respect to the attached claims.

What is claimed is:

1. A yeast-microencapsulated larvicide composition, comprising:
an active larvicide ingredient comprising at least one isoxazoline compound;
a yeast of species Saccharomyces cerevisiae, wherein the at least one isoxazoline compound is microencapsulated in the yeast.

2. The yeast-microencapsulated larvicide composition of claim 1 wherein the at least one isoxazoline compound is fluralaner.

3. The yeast-microencapsulated larvicide composition of claim 2 comprising a yeast concentration of about 0.000077 mg/mL to about 23.13 mg/mL and a fluralaner concentration of about 83.5 mg fluralaner per 1 g of yeast.

4. A method for fabricating a powdered larvicide composition, the method comprising the steps of:
preparing an encapsulation solution comprising:
an active larvicide ingredient, wherein the active larvicide ingredient comprises fluralaner in a predetermined concentration;
a yeast of species Saccharomyces cerevisiae; and
water;
agitating the encapsulation solution at a predetermined incubation temperature to obtain an incubated encapsulation solution;
separating a yeast-microencapsulated fluralaner pellet from the incubated encapsulation solution; and
freeze-drying the yeast-microencapsulated fluralaner pellet at a predetermined freeze-drying temperature to form the powdered larvicide composition.

5. The method of claim 4 wherein the step of preparing the encapsulation solution further comprises the steps of:
dissolving the fluralaner in dimethyl sulfoxide to obtain a fluralaner/dimethyl sulfoxide solution, and
then adding the yeast and the water to the fluralaner/dimethyl sulfoxide solution.

6. The method of claim 4 wherein the step of separating the yeast-microencapsulated fluralaner pellet from the incubated encapsulation solution further comprises the steps of:
centrifuging the encapsulation solution to form a supernatant and a yeast-microencapsulated fluralaner pellet;
removing the supernatant from the yeast-microencapsulated fluralaner pellet; and
washing the yeast-microencapsulated fluralaner pellet.

7. The method of claim 4 wherein the step of freeze-drying the yeast-microencapsulated fluralaner pellet further comprises the step of lyophilizing the yeast-microencapsulated fluralaner pellet at a predetermined freeze-drying temperature under a predetermined vacuum pressure to form the powdered larvicide composition.

8. The method of claim 4 wherein the encapsulation solution has a concentration ratio of about 3 to about 7 parts fluralaner, about 0.5 to about 2 parts yeast, and about 20 to about 40 parts water.

9. The method of claim 8 wherein the encapsulation solution has a concentration ratio of about 6.7 parts fluralaner to about 1 part yeast to about 33.3 parts water.

10. The method of claim 4 wherein the step of agitating the encapsulation solution further comprises agitating the encapsulation solution for about 24 hours, wherein the predetermined incubation temperature is about 40° C.

11. A method of preventing or controlling larval pest species, the method comprising the steps of:
reconstituting a powdered larvicide composition to a yeast-microencapsulated fluralaner solution, wherein the powdered larvicide composition comprises:
a larvicide ingredient comprising fluralaner; and
a yeast of species Saccharomyces cerevisiae, wherein the fluralaner is microencapsulated in the yeast; and
administering the yeast-microencapsulated fluralaner solution to a target environment.

12. The method of claim 11 wherein the larval pest species is flies, mosquitoes, or biting midges and wherein the step of administering the yeast-microencapsulated fluralaner solution to a target environment comprises administering the yeast-microencapsulated fluralaner solution to an aquatic or terrestrial environment where the larval pest species are developing.

13. The method of claim 11 wherein the step of reconstituting the powdered larvicide composition comprises diluting the powdered larvicide composition with about 1 mg/mL to about 50 mg/ml of water.

14. The method of claim 13 wherein the fluralaner in the yeast-microencapsulated fluralaner solution has a concentration of between about 0.1544753 mg/mL and about 138.2862 mg/mL, and wherein the larval pest species is Musca domestica.

15. The method of claim 14 wherein the fluralaner in the yeast-microencapsulated fluralaner solution has a concentration of between about 2.58 mg/mL and about 23.13 mg/mL.

16. The method of claim 11 wherein the step of reconstituting the powdered larvicide composition comprises diluting the powdered larvicide composition with about 0.00001 mg/mL to 0.1 mg/ml of water.

17. The method of claim 16 wherein the fluralaner in the yeast-microencapsulated fluralaner solution has a concentration of between about 8.357474×10⁻⁶ mg/mL and about 0.001781345 mg/mL, and wherein the larval pest species is Aedes albopictus.

18. The method of claim 17 wherein the fluralaner in the yeast-microencapsulated fluralaner solution has a concentration of between about 0.000077 mg/mL and about 0.00043 mg/mL.

19. The method of claim 16 wherein the fluralaner in the yeast-microencapsulated fluralaner solution has a concentration of between about 8.965623×10⁻⁷ mg/mL and about 7.78805 mg/mL, and the larval pest species is Culicoides sonorensis.

20. The method of claim 19 wherein the fluralaner in the yeast-microencapsulated fluralaner solution has a concentration of between about 0.00067 mg/mL and about 0.11637 mg/mL.
